(19) United States
(12) Patent Application Publication
(10) Pub. No.: US 2022/0405937 A1
(43) Pub. Date: Dec. 22, 2022

(54) SYSTEM AND METHOD FOR REAL-TIME CAMERA-BASED INSPECTION FOR AGRICULTURE

(71) Applicant: Agrofocal Technologies, Inc, San Jose, CA (US)

(72) Inventor: Avinash Sodani, San Jose, CA (US)

(21) Appl. No.: 17/836,774

(22) Filed: Jun. 9, 2022

Related U.S. Application Data
(60) Provisional application No. 63/213,139, filed on Jun. 21, 2021.

(51) Int. Cl. G06T 7/11; H04N 5/232

(52) U.S. Cl. CPC G06T 7/11; H04N 5/23206; G06T 2207/30188; G06T 2207/30252

(57) ABSTRACT

A new approach is proposed to support real-time camera-based agriculture inspection. One or more cameras are associated with a vehicle moving through a farm, wherein the one or more cameras each captures a plurality of images and/or video streams for an up-close, under-the-canopy view of crops on the farm. A compute box onboard the vehicle retrieves and processes the captured images and/or video streams to extract insights about current status of the crops on the farm and transmit the insights to a monitoring app running on a mobile computing device to be viewed as an inspection record by a user, e.g., farmer in real time as soon as the images and/or the video streams have been processed. The user may then control the compute box and/or the one or more cameras via the monitoring app accordingly while the vehicle is moving through the farm.

### CROSS-REFERENCE TO RELATED APPLICATIONS

This application claims the benefit of U.S. Provisional Patent Application No. 63/213,139, filed Jun. 21, 2021, which is incorporated herein in its entirety by reference.

### BACKGROUND

Agriculture inspection/monitoring/survey is a basic and fundamental activity in farming. Agriculture inspection is the activity of checking crops in a farm/field for one or more of identifying any plant health issues, estimating the produce, and planning labor deployment. Traditionally, agriculture inspection is done manually by experienced farmers walking their fields and observing the crops. Clearly with farms getting larger, e.g., many thousands of acres in size, only a small fraction of the fields can be surveyed in this fashion and it is impossible to inspect the entire field manually.

Companies providing agriculture inspection services have been working to solve this problem by using drones, aircrafts, and/or satellites to provide farm-wide images and insights. While these approaches can provide a broad overview of the farm, they can only take images and/or videos at high-altitudes while missing per-plant details. Additionally, they cannot look under the canopy and/or observe issues that require close up observations. Typically, these approaches adopt a two-step process, where the first step is to take images of the fields and upload them onto a central server, and the second step is to process the images offline and then provide insights to the user/farmer. The step of uploading images to the central server, however, is often time-consuming and in many cases requires manual intervention to get done. As such, the two-step process prevents inspecting the field in real-time and the amount of data that is required to be uploaded limits the size of the field that can be surveyed. Due to the manual intervention, the companies providing the inspection service often have to upload of the images first and provide a field report later to their customers/users, e.g., farmers, agriculture growers, and shippers. Alternatively, the customers have to do the data collection and upload the images by themselves, which they often do not have enough technical know-how to do. Since the companies providing agriculture inspection services have to be involved with data collection and processing, they can only offer to inspect the farm certain number of times at a certain schedule, which may or may not match with what is required by their customers. As such, it is usually extremely difficult for such companies to provide a farmer with agriculture inspection every day or every week for every farm the farmer owns if there is such a need.

The foregoing examples of the related art and limitations related therewith are intended to be illustrative and not exclusive. Other limitations of the related art will become apparent upon a reading of the specification and a study of the drawings.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 depicts an example of a system diagram to support real-time camera-based agriculture inspection in accordance with at least one aspect of the present embodiments.

FIGS. 2A-2D show various examples of configurations of one or more of the cameras, the compute box, the mobile device, and the cloud server depicted in FIG. 1 in accordance with at least one aspect of the present embodiments.

FIG. 3 depicts an example of a flowchart of a process to support real-time camera-based agriculture inspection in accordance with at least one aspect of the present embodiments.

### DETAILED DESCRIPTION OF EMBODIMENTS

The following disclosure provides many different embodiments, or examples, for implementing different features of the subject matter. Specific examples of components and arrangements are described below to simplify the present disclosure. These are, of course, merely examples and are not intended to be limiting. In addition, the present disclosure may repeat reference numerals and/or letters in the various examples. This repetition is for the purpose of simplicity and clarity and does not in itself dictate a relationship between the various embodiments and/or configurations discussed.

A new approach is proposed that contemplates systems and methods to support real-time camera-based agriculture inspection. One or more cameras are associated with (e.g., mounted on) a vehicle moving through a farm, wherein the one or more cameras are each configured to capture a plurality of images and/or video streams for an up-close, under-the-canopy view of crops on the farm. A compute box onboard the vehicle is configured to retrieve and process the images and/or video streams captured by the one or more cameras to extract insights about current status of the crops on the farm and transmit the insights to a monitoring app running on a mobile computing device (e.g., a mobile phone) to be viewed as an inspection record by a user, e.g., a farmer operating the vehicle, in real time as soon as the images and/or the video streams have been processed. The user may then control the compute box and/or the one or more cameras via the monitoring app to adjust the extraction, analysis, and transmission of the insights and/or the images and/or video streams accordingly while the vehicle is moving through the farm. In some embodiments, the monitoring app is further configured to upload the inspect record to a server located remotely over the Internet for further analysis.

The proposed approach enables real-time inspection of the crops on the field by collecting and processing the images and/or the video streams in real-time without any manual intervention, thus eliminating the time-consuming process of uploading the images and/or the video streams to a central server located remotely for processing. Since the entire agriculture inspection system can be completely operated by the farmer without any involvement or intervention by a third party, the farmer can monitor the farm as often as needed without any restrictions. Additionally, the proposed approach enables the farmer to perform other tasks at the same time of monitoring the field for time and cost efficiency, wherein such other tasks include but are not limited to weeding, pest-control, spraying, etc.

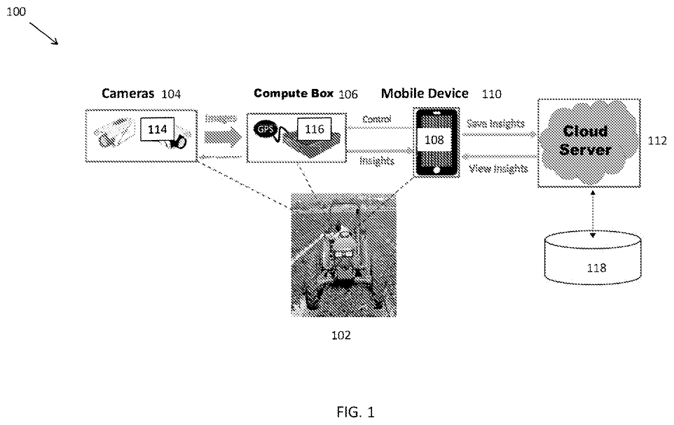

FIG. 1 depicts an example of a system diagram 100 to support real-time camera-based agriculture inspection. Although the diagrams depict components as functionally separate, such depiction is merely for illustrative purposes. It will be apparent that the components portrayed in this figure can be arbitrarily combined or divided into separate software, firmware and/or hardware components. Furthermore, it will also be apparent that such components, regardless of how they are combined or divided, can execute on the same host or multiple hosts, and wherein the multiple hosts can be connected by one or more networks.

In the example of FIG. 1, the system 100 includes one or more cameras 104 associated with a vehicle 102, a compute box 106 onboard the vehicle 102, and a monitoring app 108 running on a mobile device 110 associated with a user, e.g., a farmer, using the vehicle 102 to perform the inspection, and optionally a cloud server 112.

In the example of FIG. 1, the compute box 106 and the cloud server 112 in the system 100 is each a computing unit/appliance/device/host with software instructions stored in a storage unit such as a non-volatile memory (also referred to as secondary memory) of the computing unit for practicing one or more processes. When the software instructions are executed, at least a subset of the software instructions are loaded into memory (also referred to as primary memory) by one of the computing unit, which becomes a special purposed one for practicing the processes. The processes may also be at least partially embodied in the computing unit into which computer program code is loaded and/or executed, such that, the host becomes a special purpose computing unit for practicing the processes.

In the example of FIG. 1, the mobile device 110 in the system 100 can be a computing device, a communication device, or any device capable of running a software application. For non-limiting examples, the computing device can be but is not limited to a laptop PC, a desktop PC, a tablet, a Google Android device, an iPhone, and an iPad. Each of the one or more cameras 104s, the compute box 106, and the mobile phone 110 can communicate with each other via one or more communication networks, wherein each of the one or more communication networks can be but is not limited to, Internet, intranet, wide area network (WAN), local area network (LAN), wireless network, Bluetooth, WiFi, and a mobile communication network. The physical connections of the communication networks and the communication protocols are well known to those of skilled in the art.

In the example of FIG. 1, the one or more cameras 104s are associated with the vehicle 102 moving through a farm/field and are configured to capture a plurality of images and/or video streams for an up-close, under-the-canopy view of crops on the field as the vehicle 102 moves through the field. Here, each of the one or more cameras 104s can be but is not limited to a standalone video camera, a camera-equipped mobile device, or a surveillance camera. The one or more cameras 104s then transmit the plurality of captured images and/or video streams to the onboard compute box 106 either via a wired connection or wirelessly via Wi-Fi or Bluetooth or other wireless communication means.

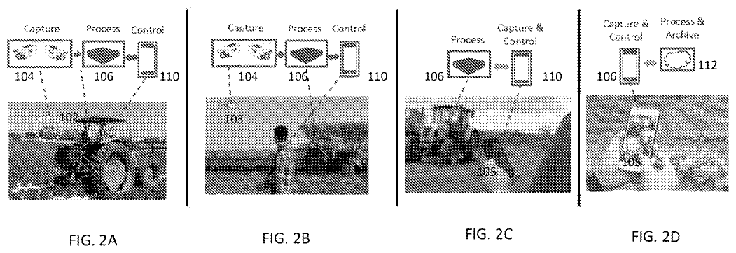

In some embodiments, the one or more cameras 104s are mounted/installed on the vehicle 102 moving through the farm as shown by the example depicted in FIG. 2A. The one or more cameras 104s mounted on the vehicle 102 are configured to collect data (e.g., the images and/or video streams) while the vehicle 102 moves through a large area of the farm. In some embodiments, the one or more cameras 104s are mounted/installed on a drone 103 flying over the farm as shown by the example depicted in FIG. 2B, wherein the one or more cameras 104s mounted on the drone 103 are configured to collect data over a large area of the farm that is not accessible or traveled less frequently by the vehicle 102 but can be covered by the drone 103 from air. In some embodiments, the one or more cameras 104s are part of a hand-held camera-enabled mobile device 105 associated with the user as shown by the example depicted in FIG. 2C, wherein the one or more cameras 104s are configured to collect data while the user is surveying an area of the farm by foot. In some embodiments, the hand-held camera-enabled mobile device 105 is configured to transmit the data collected to the cloud server 112 for processing via the monitoring app 108 running on the mobile device 110 without sending the data to be processed by the compute box 106 first as shown by the example depicted in FIG. 2D.

In some embodiments, the compute box 106 is configured to create a local Wi-Fi hotspot 116, which the one or more cameras 104 and/or the monitoring app 108 of the mobile device 110 can connect to for wireless communications with the compute box 106. In some embodiments, the local hotspot 116 created by the compute box 106 may not provide a connection to the Internet for the one or more cameras 104 and/or the monitoring app of the mobile device 110 in order protect privacy and confidential information of the farm.

In some embodiments, the one or more cameras 104s may each have its own firmware installed and an application programming interface (API) for interacting with that firmware. In some embodiments, the compute box 106 is configured to access and read frames of the images and/or video streams captured by the one or more cameras 104s via their APIs. In some embodiments, a camera app 114 running on the mobile phone is configured to stream the video over a wireless connection to the compute box 106. In some embodiments, the camera app 114 is configured to connect to the local hotspot 116 created by the compute box 106 at a pre-determined Service Set Identifier (SSID) published by the compute box 106 and to register the camera 104 running the camera app 114 with the compute box 106 in order to establish a wireless communication link for streaming of the images and/or video streams captured by the camera 104. The camera app 114 is configured to search for the pre-determined SSID of the local hotspot 116. When the camera app 114 detects the SSID, the camera app 114 is configured to connect to the local hotspot 116. In some embodiments, new SSIDs can be added to a list associated with the local hotspot 116 of the compute box 106. After connecting to the local hotspot 116, the camera app 114 gets its own IP address. In some embodiments, the camera app 114 registers the IP address of its camera 104 with the compute box 106 by sending its IP address to a predetermined port on which the compute box 106 is listening. Once the IP address is received, the compute box 106 registers the corresponding camera 104 by storing the IP address with the camera 104. In some embodiments, the compute box 106 then iterates over the one or more cameras 104s to retrieve the images and/or the video streams from each of the cameras 104s for analysis.

In some embodiments, the camera app 114 enables the user to specify mounting positions (e.g., left, right, or center) of the one or more cameras 104 on the vehicle via, for a non-limiting example, a drop-down menu, before connecting to the compute box 106. After the connection has been established, the camera app 114 is configured to send the mounting position of the corresponding camera 104 to the computer box 106 as per the selection made by the user on the camera app 114. The computer box 106 then adds the mounting position of the camera 104 to a pre-determined offset to the GPS information of the compute box 106 to approximate the GPS information of the viewing/inspecting area of the camera 104. Note that the offset may be different for different types of crops. The compute box 106 is then configured to utilize the position information of the cameras 104s to set GPS coordinates or ids for each of the images and/or video streams depending on the position of the originating camera 104. In some embodiments, the camera app 114 enables the user to start or stop streaming of the images and/or the video streams to the compute box 106.

In some embodiments, the camera app 114 of the camera 104 is configured to send a so-called “health packet” periodically to the compute box 106, wherein the health packet informs the compute box 106 that the connection to the camera 104 is not lost. In some embodiments, the camera app 114 includes its IP address as part of the health packet so that the compute box 106 may re-register the camera 104 and re-establish a connection if the current connection was lost or the IP address of the camera app 114 has changed. In some embodiments, the camera 104 stays registered with the compute box 106 until the compute box 106 is turned off or the camera app 114 is stopped. In some embodiments, stopping processing on the compute box 106 may not deregister the camera 104. In fact, the inspection could be started and stopped multiple times without disconnecting the camera 104 from the compute box 106.

In the example of FIG. 1, the compute box 106 is configured to accept and process the images and/or video streams transmitted from the one or more cameras 104s to extract a set of insights about current conditions of the crops in the field, wherein the insights about current conditions of the crops include but are not limited to plant health or produce count of the crops. In some embodiments, the compute box 106 is configured to process the images and/or video streams via artificial intelligence (AI) algorithms to identify certain patterns and/or types of objects (e.g., crops) in the images and/or video streams.

In some embodiments, the compute box 106 is configured to run a software stack that receives and processes the images and/or video streams, extracts the required insights using one or more AI models, and summarizes the inspection results in a form of an inspection record that can be displayed on the monitoring app 108 of the mobile device 110. Specifically, in some embodiments, the compute box 106 is configured to listen for one or more commands coming from the monitoring app 108 running on the mobile device 110 and takes actions accordingly. In some embodiment, the compute box 106 is configured to tag frames of the images and/or video streams with corresponding GPS information (coordinates or ids), wherein the GPS information is received by the compute box 106 directly or indirectly from the corresponding camera 104 collecting the images and/or video streams and adjusted using a predetermined offset based on the mounting position of the camera 104 on the vehicle. In some embodiment, the compute box 106 is configured to tag each of the frames with an identification or id of the corresponding camera 104 and adjust the GPS ids based on the location of the camera 104. In some embodiments, the compute box 106 is configured to track motion in a video stream frame-by-frame and enqueue the corresponding frames for processing when a pre-specified amount of motion has occurred and been detected in the video stream. In some embodiments, the compute box 106 pre-processes, e.g., partitions the frames into smaller parts and creates one or more batches of the enqueued frames for processing. The compute box 106 then performs one or more inference, e.g., non-maximum suppression (NMS), operations on the batches of frames to identify one or more objects and to obtain counts of the one or more objects in the video stream. Finally, the compute box 106 creates an inspection record with GPS id, crop counts, and any images and/or video streams that are to be included in the inspection record.

In some embodiments, the compute box 106 is configured to selectively save a subset of the images and/or video streams per user-specified policy requirements with the insights as part of the inspection record and optionally with a GPS id identifying the location of the inspection record on a map of the farm. In some embodiments, the compute box 106 is configured to continuously transmit additional inspection records to the monitoring app 108 on the mobile device 110 as the inspection of the field continues, e.g., the vehicle 102 moves through the farm. In some embodiments, the compute box 106 is configured to process the images and/or video streams without connecting to the Internet and/or signing into the cloud server 112.

In the example of FIG. 1, the monitoring app 108 running on the mobile device 110 is configured to accept the inspection record provided by the compute box 106 and to control operations of the one or more cameras 104s and/or the compute box 106 per instructions by a user (e.g., the farmer) in real time. Here, the user logs in to his/her account via a login interface provided by the monitoring app 108. In some embodiments, the monitoring app 108 enables the user to perform one or more of the following tasks: connecting the monitoring app 108 to the local hotspot 116, starting, stopping, pausing, or restarting the processing by the compute box 106, and viewing the inspection records coming from the one or more cameras 104s. While the inspection is ongoing as the vehicle 102 moves through the farm, the monitoring app 108 is configured to continuously pull the inspection records from the compute box 106 for the user to view in real-time. After the inspection is complete, the monitoring app 108 of the mobile device 110 is configured to upload the inspection record to the cloud server 112 when Internet access to the cloud server is available for the mobile device 110.

In some embodiments, the monitoring app 108 provides a pull down list of SSIDs of the local hotspot 116 for the user to select and connect to. In some embodiments, the monitoring app 108 automatically discovers and connects to the IP address and the port number of the local hotspot 116 of the compute box 106, which may reject the connection if the port is already in use. In some embodiments, the compute box 106 does not authenticate whether the mobile device 110 running the monitoring app 108 is permitted to connect to the hotspot 116 or not. However, the monitoring app 108 is not allowed to access the inspection records if the user account for the inspection service is not authenticated (e.g., login credential denied) by the cloud server 112.

In some embodiments, the monitoring app 108 is configured to control operations of the compute box 106 via on or more control commands, wherein the compute box 106 is configured to listen to and execute the commands from the monitoring app 108 on the port used to connect to the monitoring app 108. For non-limiting examples, the one or more control commands include one or more of:
Start/stop inspection or processing, which starts or stops an inspection of the field by starting or stopping transmission of the images and/or the video streams from the one or more cameras 104s to the compute box 106 and processing of the images and/or the video streams by the compute box 106.
Start/stop preview, which starts or stops displaying the images and/or the video streams from the certain selected cameras 104s to the monitoring app 108 for preview by the user either before or during processing of the images and/or the video streams by the compute box 106. In some embodiments, the user may select a certain camera for preview by selecting the camera's id from pop-up menu.
Get records, which reads/transmits the inspection record from the compute box 106 to the monitoring app 108. In some embodiments, this command is sent by the monitoring app 108 to the compute box 106 periodically after the compute box 106 starts processing the images and/or the video streams to continuously read out the inspection record incrementally. The monitoring app 108 sends this command for the last time to read out the remaining portion of the inspection record after the processing has stopped.

In some embodiments, the monitoring app 108 is configured to enable the user to login to and access the user's account on the cloud server 112, and to manage subscription information to an inspection service, e.g., renew/upgrade subscription of the user. Once logged in, the user may access, e.g., browse through all inspection records that are marked on the map of the farm based on their GPS ids via the monitoring app 108 if the user's subscription to the inspection service is active. In some embodiments, the monitoring app 108 is configured to present all inspection records retrieved from the cloud server 112 in a list format or a calendar format. Under the calendar format, the user may view all inspection records from a certain date by clicking on that date in the calendar. In some embodiments, the monitoring app 108 presents the user with a drop-down menu where one or more fields can be selected by the user to start an inspection. For each field to be inspected, the monitoring app 108 is configured to present one or more of following information to the user: field name, date, list of object names and their corresponding counts, and total count of all objects/crops in the field. In some embodiments, the monitoring app 108 is configured to enable the user to browse these inspection records and visualize them on an interactive map that shows the inspection records based on their GPS locations (e.g. ids). In some embodiments, the monitoring app 108 enables the user to zoom in and out to view more or less details of the inspection records and to get statistics of the crops on the farm, e.g., counts for different objects in a selected region of the map of the farm under view. In some embodiments, the monitoring app 108 presents some of the inspection records with associated images and/or video streams to be clicked and viewed by the user. In some embodiments, the monitoring app 108 is configured to present to the user with a forecast yield in the future, e.g., over next week, month or year, specific to the type of the crop being inspected.

In the example of FIG. 1, the cloud server 112 is configured to accept and maintain the inspection records uploaded by the monitoring app 108 of the mobile device 110 to the cloud over Internet. In some embodiments, the cloud server 112 can only be accessed via the monitoring app 108 using the user's login account and password as discussed above. After the user logs in, the cloud server 112 checks and sends account information of the inspection service of the user to the monitoring app 108 running on the mobile device 110 of the user. In some embodiments, the cloud server 112 is configured to provide backend support for real-time inspection, wherein such support includes but is not limited to managing user accounts, managing subscription by the user to the inspection service, maintaining the inspection records in the monitoring database 118, calculating area of the farm covered by the inspection, and serving requests to access the inspection records via the monitoring app 108. Specifically, the cloud server 112 is configured to support user account and inspection service subscription management, which include but are not limited to user account creation, user account login credential checking, subscription level of the inspection service, subscription renewal and/or upgrade. For non-limiting examples, the inspection service subscription includes one or more of the following: crop type(s) subscribed, monitoring level subscribed, wherein each subscription level comes with different features such as types of crops, numbers of geographical acres of the farm included per year as part of subscription, and the number or percentage of acres already used. In some embodiments, the cloud server 112 is configured to calculate the number of acres covered per inspection record and increment the amount of new geographical acres covered. If this number exceeds the current subscription level or the subscription has expired, the cloud server 112 will prompt the user for an upgrade via the monitoring app 108. Although the inspection may continue to proceed, the monitoring app 108 will stop displaying any data from the exceeded part of the acreage of the farm to the user. For example, link to the inspection records will be greyed out and a pop-up will inform the user why the inspection records are not viewable.

In some embodiments, the monitoring database 118 is configured to maintain the inspection records of the farm as well as associated information uploaded from the monitoring app 108 to the cloud server 112. In some embodiments, the monitoring database 118 is configured to assign an inspection record id for each of the inspection records and maintain the inspection records in separate files and/or directories based on the timestamps of the inspection records. For non-limiting examples, the types of information stored per inspection record in the monitoring database 118 include one or more of: date of field recording of the inspection record, area of the farm covered by inspection record, GPS id of the inspection record, a list of objects and their corresponding counts of the field covered by the inspection record, and a list of images and/or video streams of the field covered. In some embodiments, the monitoring database 118 can be accessed by the monitoring app 108.

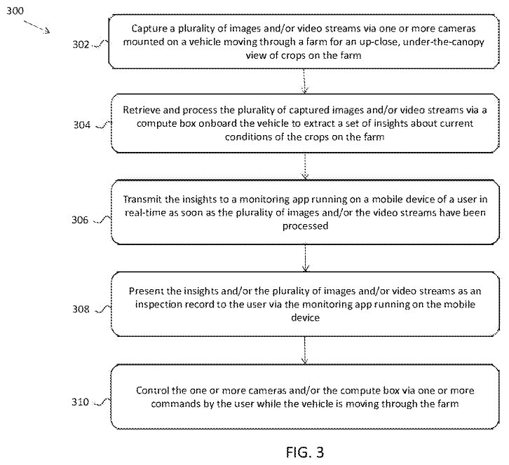

FIG. 3 depicts a flowchart 300 of an example of a process to support real-time camera-based agriculture inspection. Although the figure depicts functional steps in a particular order for purposes of illustration, the processes are not limited to any particular order or arrangement of steps. One skilled in the relevant art will appreciate that the various steps portrayed in this figure could be omitted, rearranged, combined, and/or adapted in various ways.

In the example of FIG. 3, the flowchart 300 starts at block 302, where a plurality of images and/or video streams are captured via one or more cameras associated with a vehicle moving through a farm for an up-close, under-the-canopy view of crops on the farm. The flowchart 300 continues to block 304, where the plurality of captured images and/or video streams are retrieved and processed via a compute box onboard the vehicle to extract a set of insights about current conditions of the crops on the farm. The flowchart 300 continues to block 306, where the insights are transmitted to a monitoring app running on a mobile device of a user in real-time as soon as the plurality of images and/or the video streams have been collected. The flowchart 300 continues to block 308, where the insights and/or the plurality of images and/or video streams are presented as an inspection record to the user via the monitoring app running on the mobile device. The flowchart 300 ends at block 310, where the one or more cameras and/or the compute box are controlled via one or more commands by the user while the vehicle is moving through the farm.

The foregoing description of various embodiments of the claimed subject matter has been provided for the purposes of illustration and description. It is not intended to be exhaustive or to limit the claimed subject matter to the precise forms disclosed. Many modifications and variations will be apparent to the practitioner skilled in the art. Embodiments were chosen and described in order to best describe the principles of the invention and its practical application, thereby enabling others skilled in the relevant art to understand the claimed subject matter, the various embodiments and the various modifications that are suited to the particular use contemplated.

What is claimed is:

1. A system to support real-time agriculture inspection, comprising:
one or more cameras associated with a vehicle moving through a farm, wherein each of the one or more cameras is configured to capture a plurality of images and/or video streams for an up-close, under-the-canopy view of crops on the farm;
said compute box onboard the vehicle and configured to:
retrieve and process the plurality of captured images and/or video streams to extract a set of insights about current conditions of the crops on the farm;
transmit the insights to a monitoring app running on a mobile device of a user in real-time as soon as the plurality of images and/or the video streams have been processed;
said monitoring app running on the mobile device of the user configured to
present the insights and/or the plurality of images and/or video streams as an inspection record to the user;
control the one or more cameras and/or the compute box via one or more commands by the user while the vehicle is moving through the farm.

2. The system of claim 1, wherein:
the compute box is configured to create a local hotspot for wireless communication with the one or more cameras and/or the monitoring app running on the mobile device, wherein the local hotspot does not provide a connection to the Internet for the one or more cameras and/or the monitoring app of the mobile device in order protect privacy and confidential information of the farm.

3. The system of claim 2, wherein:
the local hotspot does not provide a connection to the Internet for the one or more cameras and/or the monitoring app of the mobile device in order protect privacy and confidential information of the farm.

4. The system of claim 1, wherein:
the compute box is configured to register the one or more cameras based on IP addresses of the one or more cameras.

5. The system of claim 1, wherein:
each of the one or more cameras are each configured to send a packet periodically to the compute box, wherein the packet informs the compute box that the connection to the each of the one or more cameras is not lost.

6. The system of claim 1, wherein:
the compute box is configured to tag the plurality of images and/or video streams with corresponding GPS information, wherein the GPS information is received from the corresponding camera collecting the images and/or video streams and is adjusted using a predetermined offset based on a mounting position of the camera on the vehicle.

7. The system of claim 1, wherein:
the compute box is configured to track motion in one of the video stream frame-by-frame and to enqueue corresponding frames for processing when a pre-specified amount of motion has been detected in the video stream.

8. The system of claim 7, wherein:
the compute box is configured to perform one or more inference operations on the frames to identify one or more objects and to obtain counts of the one or more objects in the video stream.

9. The system of claim 1, wherein:
the compute box is configured to continuously transmit additional inspection records to the monitoring app on the mobile device as the vehicle moves through the farm.

10. The system of claim 1, wherein:
the compute box is configured to listen to and execute the one or more commands on a port used to connect to the monitoring app.

11. The system of claim 1, further comprising:
a cloud server located remotely and configure to manage and analyze the inspection record uploaded by the monitoring app running on the mobile device.

12. The system of claim 11, wherein:
the one or more cameras are configured to transmit the plurality of images and/or video streams to the cloud server for processing via the monitoring app without being processed by the compute box first.

13. The system of claim 11, wherein:
the monitoring app is configured to upload the inspection record to the cloud server when Internet access to the cloud server is available for the mobile device.

14. The system of claim 11, wherein:
the monitoring app is configured to present all inspection records retrieved from the cloud server in a list format, a calendar format, or interactively via a map of the farm.

15. The system of claim 14, wherein:
the monitoring app is configured to enable the user to zoom in and out to view more or less details of the inspection records and to get statistics of the crops on the farm in a selected region of the map of the farm under view.

16. The system of claim 1, wherein:
the one or more cameras are mounted on the vehicle moving through the farm.

17. The system of claim 1, wherein:
the one or more cameras are mounted on a drone flying over the farm.

18. The system of claim 1, wherein:
the one or more cameras are part of a hand-held camera-enabled mobile device associated with the user.

19. A method to support real-time agriculture inspection, comprising:
capturing a plurality of images and/or video streams via one or more cameras associated with a vehicle moving through a farm for an up-close, under-the-canopy view of crops on the farm;
retrieving and processing the plurality of captured images and/or video streams via a compute box onboard the vehicle to extract a set of insights about current conditions of the crops on the farm;
transmitting the insights to a monitoring app running on a mobile device of a user in real-time as soon as the plurality of images and/or the video streams have been processed;
presenting the insights and/or the plurality of images and/or video streams as an inspection record to the user via the monitoring app running on the mobile device;
controlling the one or more cameras and/or the compute box via one or more commands by the user while the vehicle is moving through the farm.

20. The method of claim 19, further comprising:
creating a local hotspot for wireless communication with the one or more cameras and/or the monitoring app running on the mobile device.

21. The method of claim 19, further comprising:
registering the one or more cameras based on IP addresses of the one or more cameras.

22. The method of claim 19, further comprising:
tagging the plurality of images and/or video streams with corresponding GPS information, wherein the GPS information is received from the corresponding camera collecting the images and/or video streams and is adjusted using a predetermined offset based on a mounting position of the camera on the vehicle.

23. The method of claim 19, further comprising:
tracking motion in one of the video stream frame-by-frame and enqueuing corresponding frames for processing when a pre-specified amount of motion has been detected in the video stream;
performing one or more inference operations on the frames to identify one or more objects and to obtain counts of the one or more objects in the video stream.

24. The method of claim 19, further comprising:
continuously transmitting additional inspection records to the monitoring app on the mobile device as the vehicle moves through the farm.

25. The method of claim 19, further comprising:
listening to and executing the one or more commands on a port used to connect to the monitoring app.

26. The method of claim 19, further comprising:
managing and analyzing the inspection record uploaded by the monitoring app running on the mobile device to a cloud server located remotely.

27. The method of claim 26, further comprising:
transmitting the plurality of images and/or video streams to the cloud server for processing via the monitoring app without being processed by the compute box first.

28. The method of claim 26, further comprising:
uploading the inspection record to the cloud server when Internet access to the cloud server is available for the mobile device.

29. The method of claim 26, further comprising:
presenting all inspection records retrieved from the cloud server in a list format, a calendar format, or interactively via a map of the farm.

30. The method of claim 29, further comprising:
enabling the user to zoom in and out to view more or less details of the inspection records and to get statistics of the crops on the farm in a selected region of the map of the farm under view.
